(19) United States
(12) Patent Application Publication
(10) Pub. No.: US 2014/0312906 A1
(43) Pub. Date: Oct. 23, 2014

(54) FRACTAL SHAPED ANTENNA FOR DOWNHOLE LOGGING

(71) Applicant: Randy Gold, Houston, TX (US)

(72) Inventor: Randy Gold, Houston, TX (US)

(73) Assignee: BAKER HUGHES INCORPORATED, Houston, TX (US)

(21) Appl. No.: 13/868,609

(22) Filed: Apr. 23, 2013

(51) Int. Cl. G01V 3/12

(52) U.S. Cl. CPC G01V 3/12
USPC 324/334

(57) ABSTRACT

An apparatus for estimating a subsurface material property includes: a first energy interface device configured to transmit electromagnetic or electrical energy into the subsurface material; a second energy interface device configured to receive return electromagnetic or electrical energy due to the transmitted electromagnetic or electrical energy interacting with the subsurface material; and a processor configured to estimate the property using a signal received from the second device; wherein at least one of the first energy interface device and the second energy interface device is a fractal-shaped antenna comprising a base motif figure and at least one scaled down replication of the base motif figure, the at least one replication being a change from the base motif by at least one of a linear displacement translation and a rotation, and a position of the replication upon the base motif figure is by at least one of rotation, translation, and stretching.

### BACKGROUND

Earth formations may be used for various purposes such as hydrocarbon production, geothermal production, and carbon dioxide sequestration. In order to efficiently use an earth formation, the formation is characterized by performing measurements of many different properties using one or more tools conveyed through a borehole penetrating the formation. One category of tools includes tools that measure electrical characteristics of the earth formation such as resistivity or dielectric constant. Conventional resistivity and dielectric tools typically use a coil as an antenna to transmit electromagnetic signals into or receive electromagnetic signals from the formation in order to measure the resistivity or dielectric constant. Due to the physical size constraints imposed by the borehole, the desired transmitting efficiency for probing deep into the formation may be compromised. Hence, it would be well received in the drilling and geophysical exploration industries if designs of resistivity and dielectric tools could be improved to probe deeper into earth formations.

### BRIEF SUMMARY

Disclosed is an apparatus for estimating a property of a subsurface material. The apparatus includes: a carrier configured to be conveyed through a borehole penetrating the subsurface material; a transmitter configured to transmit a first electrical signal; a first energy interface device disposed at the carrier, coupled to the transmitter, and configured to transmit at least one of electromagnetic energy and electrical energy into the subsurface material; a second energy interface device disposed at the carrier and configured to receive at least one of return electromagnetic energy and return electrical energy due to at least one of transmitted electromagnetic energy and transmitted electrical energy interacting with the subsurface material; a receiver coupled to the second antenna and configured to receive a second electrical signal from the second energy interface device; and a processor coupled to the receiver and configured to estimate the property using the second electrical signal; wherein at least one of the first energy interface device and the second energy interface device is a fractal-shaped antenna having a base motif figure and at least one scaled down replication of the base motif figure, the at least one replication being a change from the base motif by at least one of a linear displacement translation and a rotation, and a position of the replication upon the base motif figure is by at least one of rotation, translation, and stretching.

Also disclosed is a method for estimating a property of a subsurface material, the method includes: conveying a carrier through a borehole penetrating the subsurface material; transmitting at least one of electromagnetic energy and electrical energy into the subsurface material using a first energy interface device disposed at the carrier and coupled to a transmitter configured to transmit a first electrical signal to the first energy interface device; receiving at least one of return electromagnetic energy and return electrical energy from the subsurface material due to the at least one transmitted electromagnetic energy and transmitted electrical energy interacting with the formation using a second energy interface device disposed at the carrier and coupled to a receiver configured to receive a second electrical signal from the second energy interface device; and estimating the property using a processor coupled the receiver and configured to estimate the property using the second electrical signal; wherein at least one of the first energy interface device and the second energy interface device is a fractal-shaped antenna having a base motif figure and at least one scaled down replication of the base motif figure, the at least one replication being a change from the base motif by at least one of a linear displacement translation and a rotation, and a position of the replication upon the base motif figure is by at least one of rotation, translation, and stretching.

### BRIEF DESCRIPTION OF THE DRAWINGS

The following descriptions should not be considered limiting in any way. With reference to the accompanying drawings, like elements are numbered alike:

FIG. 1 illustrates a cross-sectional view of an exemplary embodiment of a downhole tool disposed in a borehole penetrating the earth;

FIG. 2 depicts aspects of a fractal-shaped antenna disposed at the downhole tool;

FIG. 3 depicts aspects of the fractal-shaped antenna disposed in a recess in a tool body of the downhole tool;

FIG. 4 depicts aspects of the fractal-shaped antenna disposed on an outer surface of a body of the downhole tool;

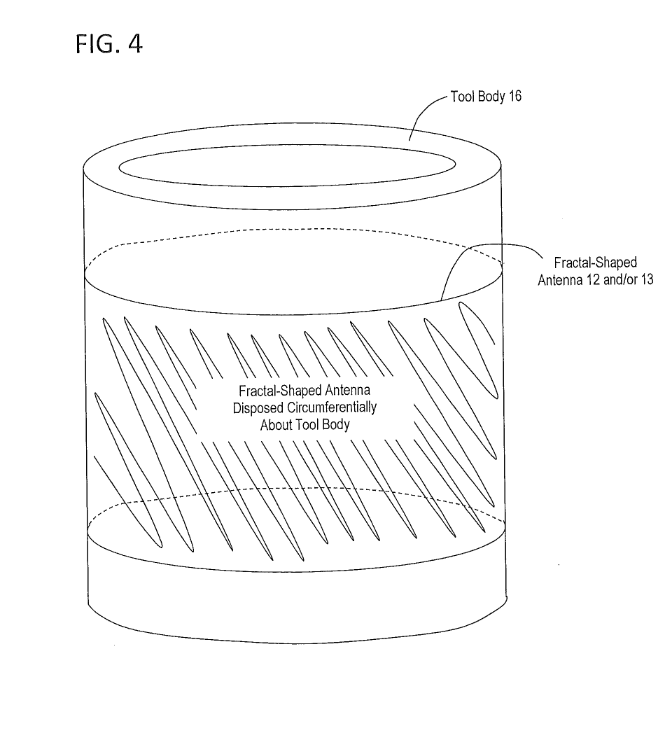

FIG. 5 depicts aspects of the fractal-shaped antenna disposed 360-degrees about the body of the downhole tool;

FIG. 6 depicts aspects of a fractal-shaped antenna having a plurality of connections to a switching network;

FIG. 7 depicts aspects of electrodes disposed on a pad for receiving return electrical signals; and

FIG. 8 is a flow chart of a method for estimating a property of an earth formation penetrated by a borehole.

### DETAILED DESCRIPTION

A detailed description of one or more embodiments of the disclosed apparatus and method presented herein by way of exemplification and not limitation with reference to the figures.

Disclosed are apparatus and method for estimating resistivity or its inverse conductivity, dielectric constant, or some other property of an earth formation. A downhole tool, in one or more embodiments, is configured to transmit electromagnetic signals into the earth formation using a fractal-shaped antenna and receive return electromagnetic signals from the earth formation using the same or another fractal-shaped antenna. The fractal-shaped antenna increases the efficiency of the antenna for a given amount of area or volume that is constrained by the physical dimensions of the borehole. The increased efficiency enables the downhole tool to probe deeper into the earth formation than would be possible using a conventional antenna. Further, the fractal-shaped antenna may be designed to have a plurality of non-harmonic resonant frequencies, as demonstrated by modeling using numerical tools, to enable probing various regions of the formation under different conditions requiring different probing frequencies.

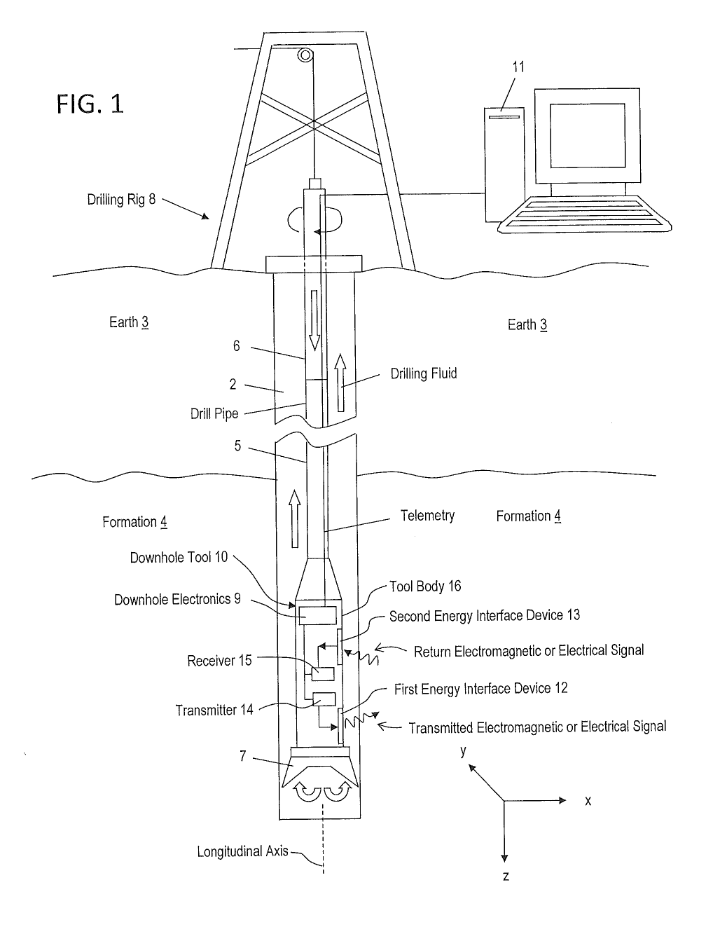

FIG. 1 illustrates a cross-sectional view of an exemplary embodiment of a downhole tool 10 disposed in a borehole 2 penetrating the earth 3, which includes an earth formation 4. The downhole tool 10 in FIG. 1 includes a tool body 16 that provides a support structure or protection for components of the tool 10. The formation 4 represents any subsurface material of interest that may be sensed by the tool 10. The subsurface material can include an earth formation material and/or a material disposed in the borehole 2, any of which may be in the form of a solid, liquid and/or gas. The downhole tool 10 is conveyed through the borehole 2 by a carrier 5, which can be a drill tubular such as a drill string 6. A drill bit 7 is disposed at the distal end of the drill string 6. A drill rig 8 is configured to conduct drilling operations such as rotating the drill string 6 and thus the drill bit 7 in order to drill the borehole 2. In addition, the drill rig 8 is configured to pump drilling fluid through the drill string 6 in order to lubricate the drill bit 7 and flush cuttings from the borehole 2. Downhole electronics 9 are configured to operate the downhole tool 10, process measurement data obtained downhole, and/or act as an interface with telemetry to communicate data or commands between downhole components and a computer processing system 11 disposed at the surface of the earth 3. Non-limiting embodiments of the telemetry include pulsed-mud and wired drill pipe. System operation and data processing operations may be performed by the downhole electronics 9, the computer processing system 11, or a combination thereof. The downhole tool 10 may be operated continuously or at discrete selected depths in the borehole 2 or may be placed in a stationary in situ embodiment. In an alternative embodiment, the carrier 5 may be an armored wireline, which can also provide communications between the downhole electronics 9 and the processing system 11.

The downhole tool 10 may be configured to measure the resistivity, or its inverse conductivity, or a dielectric constant of the formation 4. Resistivity measurements involve a first energy interface device 12 transmitting electromagnetic or electrical energy of a certain frequency (generally from about 100 kHz to about 10 MHz) into the formation 4. The electromagnetic energy relates to electromagnetic waves or signals while the electrical energy relates to electrical current, which may be galvanic or displacement. Galvanic current relates to galvanic coupling where electrons flow directly from the first energy interface device 12 into the formation 4 (or subsurface material of interest) while displacement current relates to current flowing due to capacitive coupling. In embodiments where the transmitted energy is electromagnetic energy, the first energy interface device is an antenna, which may be referred to as the first antenna 12. In embodiments where the transmitted energy is electrical energy, the first energy interface device 12 is one or more electrodes. The transmitted electromagnetic or electrical energy induces circulating electric currents in the formation 4. The transmitted electrical energy causes electrical current to flow in the formation 4. The circulating currents or other currents in turn emit return energy or signals that are received by a second energy interface device 13. In embodiments where the return energy or signals are electromagnetic, the second energy interface device 13 is an antenna, which may be referred to as the second antenna 13. In one or more embodiments, one antenna is used for both transmitting and receiving electromagnetic signals (i.e., the first antenna 12 and the second antenna 13 are the same antenna). In embodiments where the return energy signals are electrical, the second energy interface device 13 is one or more electrodes. Return electrical signals may be measured as a voltage difference between one electrode and a reference voltage, such as a tool body potential, or between two or more electrodes.

It can be appreciated that lower formation resistivity will induce higher circulating currents or other currents in the formation 4. Hence, the magnitude of the return electromagnetic or electrical signals is related to the magnitude of the resistivity or conductivity of the formation 4. In one or more embodiments, changes in the measured resistivity or conductivity with depth are displayed or plotted as an image. The image may be in an azimuthal or radial direction from the borehole or it may be a 360 degree circumferential image around the borehole.

As illustrated in FIG. 1, the first energy interface device 12 is coupled to a transmitter 14 and the second energy interface device 13 is coupled to a receiver 15. The transmitter 14 is configured to transmit electric current at the frequency desired for the electromagnetic or electrical signals transmitted by the first energy interface device 12 into the subsurface material of interest. The transmitter 14 may also be coupled to the downhole electronics 9 or the computer processing system 11 for receiving commands related to the operation of the downhole tool 10. The receiver 15 is configured to receive electrical signals from the second energy interface device 13 for processing, which may include amplification and/or conversion to a format for transmitting received information to the downhole electronics 9 or the computer processing system 11.

The downhole tool 10 may be configured to measure the dielectric constant (also referred to as dielectric permittivity) of the formation 4. These types of measurements, in one or more embodiments, involve transmitting electromagnetic energy that propagates through the formation 4 using the first antenna 12 and is received using the second antenna 13. In these embodiments, the received electromagnetic energy may also be referred to as return electromagnetic energy. The frequency of the transmitted electromagnetic energy is generally higher than the frequency used for resistivity logging and is generally from about 20 MHz and into the GHz range. Measurements of the propagation electromagnetic signals in order to determine the dielectric permittivity include signal attenuation and signal phase-shift. Using these measurements in addition to the conductivity and magnetic permeability of the formation, the dielectric constant may be determined using Maxwell's equations as known in the art. In addition, porosity of the formation may be determined using measurements of the signal propagation time using equations known in the art knowing that the propagation time in a formation that is a water filled matrix is substantially higher than that in a hydrocarbon filled matrix. These types of measurements may also be performed using one fractal-shaped antenna in conjunction with one or more electrodes.

It can be appreciated that signal attenuation and phase-shift measurements may be performed by comparing the received electromagnetic signals to a reference signal, which may be generated by a processor. In one or more embodiments, the reference signal may be the transmitted electromagnetic signal or electrical signal transmitted to the first antenna 12 by the transmitter.

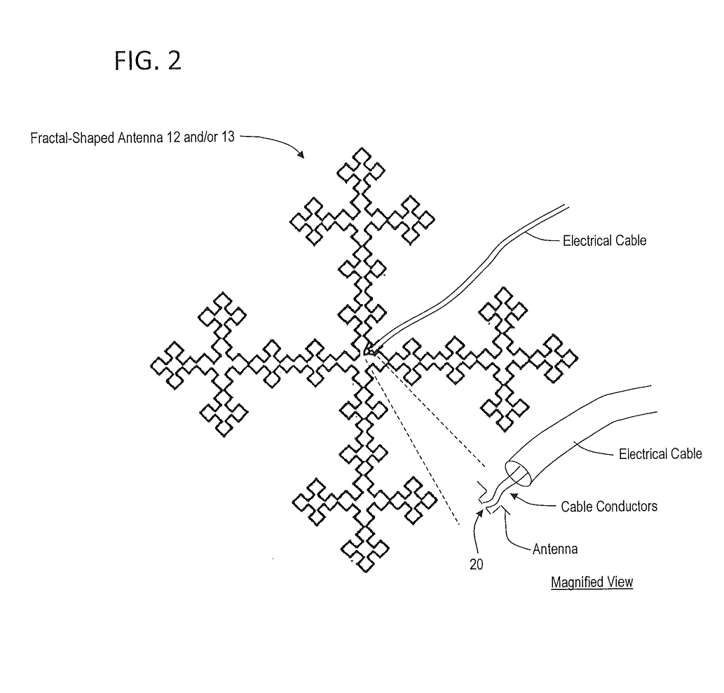

Reference may now be had to FIG. 2, which depicts aspects of one example of an antenna having a fractal shape that may be used for the first antenna 12 and/or the second antenna 13. The magnified view illustrates a connection 20 for connecting conductors of an electrical cable to the fractal-shaped antenna. The fractal shape may be any shape having a base pattern or motif and a self-similar design. The fractal shape includes a scaled down replication of the base motif The first scaled-down replication superimposed over a base motif figure may be referred to as a first iteration (i.e., N=1). The additional superposition of another replication to yet a smaller scale would be the second iteration (i.e., N=2). Each replication may be changed from the base motif by linear displacement and/or rotation. The fractal may be defined as a superposition of one or more scaled-down replications (i.e., one or more iterations) superimposed over the base motif figure. The positioning of each replication may be performed by rotation, stretching, and translation. It can be appreciated that different fractal shapes may include straight and/or non-straight lines. Examples of motifs known in the art include Koch, Minkowski, Cantor, torn square, Mandelbrot, Caley tree, monkey's swing, Sierpinski gasket, and Julia. In that fractal antennas and terms for describing fractal antennas or fractal-shaped antennas are known in the art, these terms are no longer discussed in detail herein.

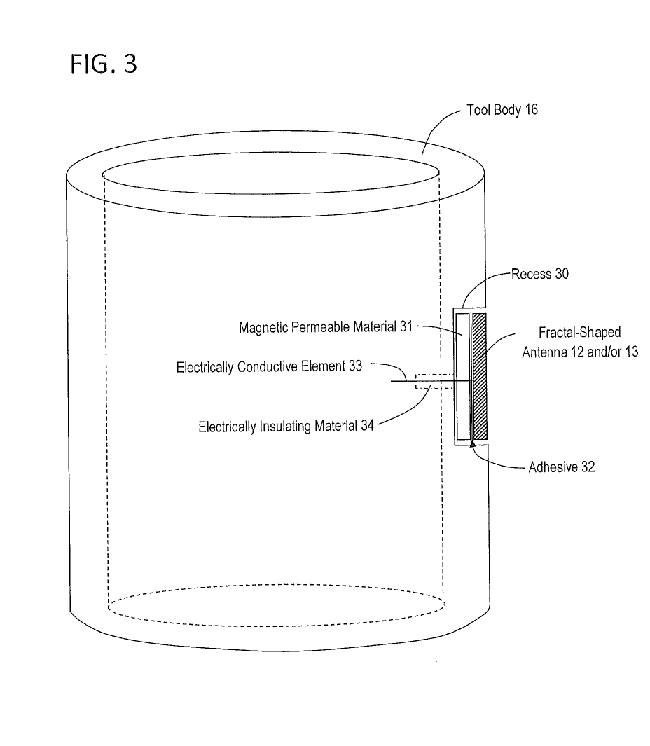

In one or more embodiments, the first antenna 12 and/or second antenna 13 may be disposed in a recess 30 in the tool body 16 as illustrated in the cross-sectional view of a section of the tool body 16 in FIG. 3. An outer surface of the antennas 12 and/or 13 may be flush with or recessed from an outer surface of the tool body 16 in order to prevent or limit abrasion due to contact with the borehole wall. In one or more embodiments, a magnetic permeable material 31 may be disposed between the antennas 12 and/or 13 and the tool body 16. The magnetic permeable material 31 being configured to direct magnetic flux away from the tool body 16 in order to prevent the tool body 16 from interfering with electromagnetic signals. In one or more embodiments, the antennas 12 and/or 13 may be secured to the tool body 16 or the magnetic permeable material 31 using an adhesive 32. In one or more embodiments, the first antenna 12 and/or the second antenna 13 may be disposed within the tool body 16 when the tool body 16 is non-metallic. The antennas 12 and/or 13 may be configured to have a transmission direction or sensitivity direction that is radial to the tool 10, longitudinal to the tool 10, or at an angle that has both a radial component and a longitudinal component. In one or more embodiments, an electrically conductive element 33 is coupled to the first antenna 12 and/or second antenna 13 and extends into or penetrates the tool body 16 where the element 33 is coupled to the transmitter 14 or the receiver 15. It can be appreciated that when the tool body 16 is metal, the element 33 is insulated from the tool body 16 by an electrically insulating material 34.

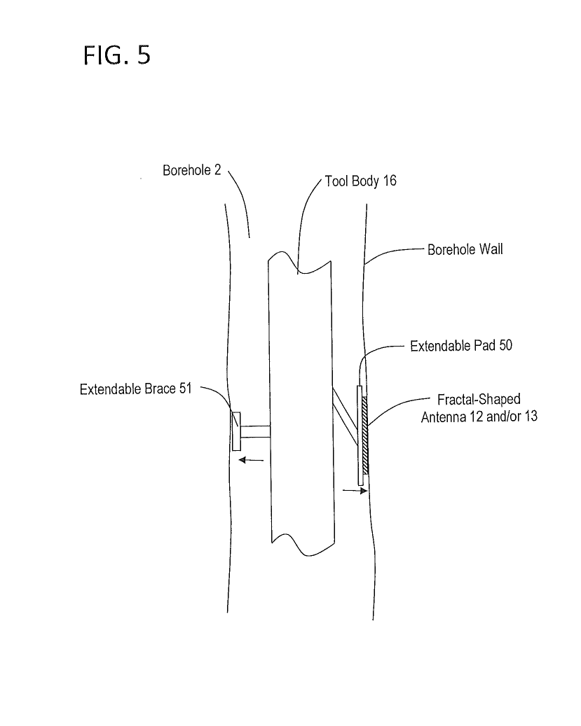

In one or more embodiments, the first antenna 12 and/or the second antenna 13 is disposed circumferentially for 360 degrees about a longitudinal axis of the downhole tool 10 either on the outer surface of the tool body 16 as illustrated in FIG. 5 or internal to the tool body 16 when the tool body 16 is non-metallic.

In one or more embodiments for resistivity or dielectric logging, the first antenna 12 and/or the second antenna 13 may disposed on a pad 50 as illustrated in FIG. 5. The pad 50 is configured to extend from the tool 10 and make contact with the borehole wall. An extendable brace 51 may be used to keep the tool 10 in position in order for the pad 50 and thus associated antennas to maintain contact with the borehole wall.

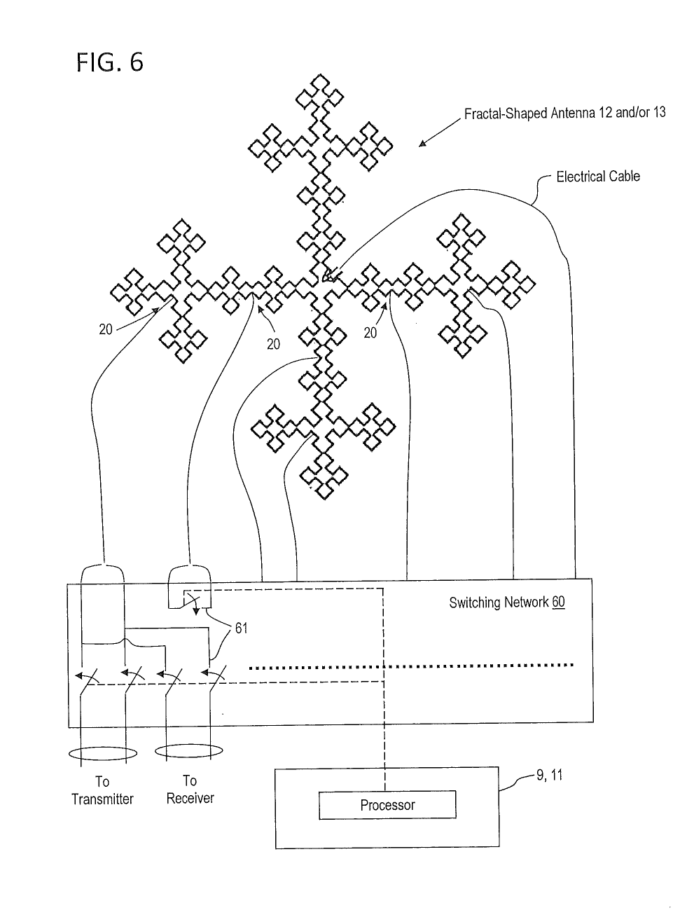

In one or more embodiments, the antenna 12 and/or the antenna 13 may have a plurality of connections 20 as illustrated in FIG. 6. Each connection 20 has two conductors for applying or receiving electric signals. The plurality of connections 20 may be configured to partition or reconfigure either antenna into a plurality of sections or different shapes to enable directional steering for transmission or reception of electromagnetic signals. Each connection 20 may be coupled to a switching network 60. The switching network 60 includes a network of remotely-controlled switches 61, which may be relays or semiconductor switches. The switches 61 are configured to be controlled by a processor in the downhole electronics 9 and/or the computer processing system 11. The processor is configured to implement an algorithm for operating the switches in order to operate the fractal-shaped antenna is a desired manner for a selected type of downhole logging requiring a selected configuration of the first antenna 12 and/or the second antenna 13. Connections 20 not used for transmission or reception may be left open-circuited or short-circuited depending on the final desired shape of the antennas. Further, one or more connections 20 may be connected to the transmitter 14 or the receiver 15 by opening or closing certain switches 61 to produce a desired network configuration.

It can be appreciated that the downhole tool 10 may be calibrated for the various formation properties of interest that may be determined by the tool 10 by analysis, field calibration, and/or laboratory calibration. Calibration by analysis involves using known software packages for modeling antennas and propagation of electromagnetic signals through materials having the various electrical properties of interest. Field calibration involves calibrating the downhole tool 10 in one or more formations having known electrical properties. Laboratory calibration involves calibrating the downhole tool 10 in a laboratory using reference materials having known electrical properties of interest to simulate various formation electrical properties. Any of these methods may be used to calibrate the tool 10 such that the tool 10 will output an accurate value of a measured property of interest when the tool probes the formation having that value. Calibration values may be stored in a look-up table that a processor may reference a received signal to in order to estimate the property of interest.

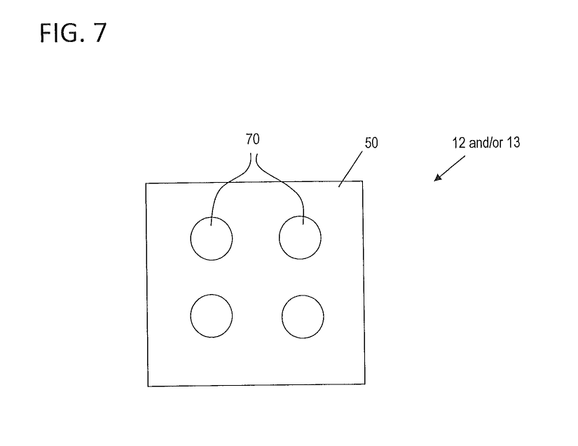

It can be appreciated that in one or more embodiments the first antenna 12 may be a conventional antenna (e.g., a coil) operated in conjunction with a fractal-shaped second antenna 13 or the first antenna 12 may be fractal-shaped and operated in conjunction with a conventional second antenna 13. Alternatively, both the first antenna 12 and the second antenna 13 may be fractal-shaped antennas as described above. In one or more embodiments, the transmitting energy interface device (i.e., the first energy interface device 12) is one or more electrodes while the receiving energy interface device (i.e., the second energy interface device 13) is a fractal-shaped antenna. Alternatively, in one or more embodiments, the transmitting energy interface device is a fractal-shaped antenna while the receiving energy interface device is one or more electrodes. In general, an electrode may be in electrical contact with the borehole wall or subsurface material of interest for galvanic coupling when electrons can flow from the electrode to the subsurface material of interest or for capacitive coupling with a nonconductive material of interest for displacement current flow. In one or more embodiments, the one or more electrodes 70 used for the first energy interface device 12 or the second energy interface device 13 are disposed on the extendable pad 50 as illustrated in FIG. 7.

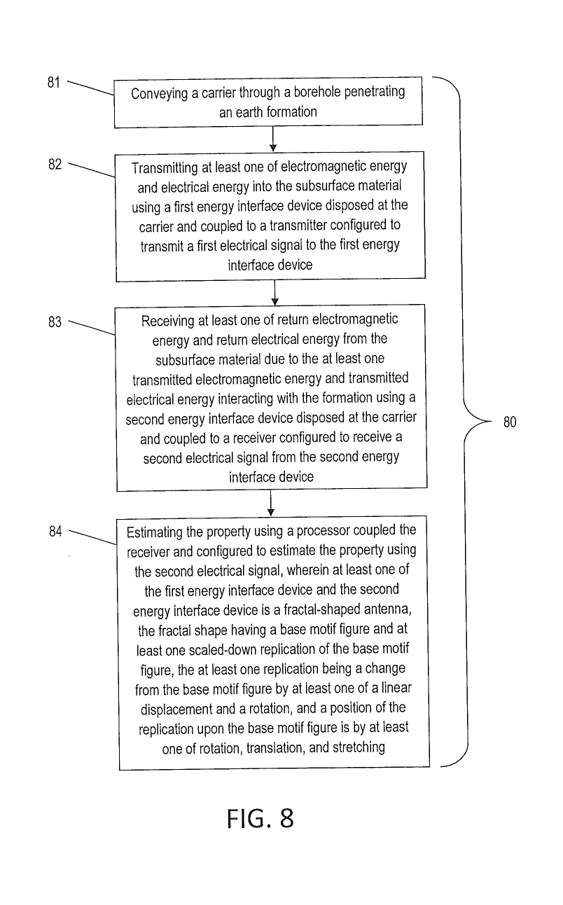

FIG. 8 is a flow chart for a method 80 for estimating a property of an earth formation. Block 81 calls for conveying a carrier through a borehole penetrating an earth formation. Block 82 calls for transmitting at least one of electromagnetic energy and electrical energy into the subsurface material using a first energy interface device disposed at the carrier and coupled to a transmitter configured to transmit a first electrical signal to the first energy interface device. Block 83 calls for receiving at least one of return electromagnetic energy and return electrical energy from the subsurface material due to the at least one transmitted electromagnetic energy and transmitted electrical energy interacting with the formation using a second energy interface device disposed at the carrier and coupled to a receiver configured to receive a second electrical signal from the second energy interface device. Block 84 calls for estimating the property using a processor coupled the receiver and configured to estimate the property using the second electrical signal. At least one of first energy interface device and the second energy interface device is a fractal-shaped antenna. The fractal shape of the antenna includes a base motif figure and at least one scaled down replication of the base motif figure, the at least one replication being a change from the base motif figure by at least one of a linear displacement and a rotation, and a position of the replication upon the base motif figure is by at least one of rotation, translation, and stretching.

It can be appreciated that the fractal-shaped antenna may be used in other applications in a borehole. In one or more embodiments, the fractal-shaped antenna is used to enable wireless communications between two or more downhole tools disposed in a bottomhole assembly (BHA), between downhole tools disposed in different drill pipes in a drill string, or between permanent downhole valves, sensors, or processing systems. An example of a BHA is the downhole tool and drill bit assembly shown FIG. 1. The BHA may include several downhole tools or other devices such as a mud motor for turning the drill bit. Each downhole tool communicating wirelessly with other tools or devices may include or be coupled to a fractal-shaped antenna. Because of downhole tool spatial constraints due to the size of the borehole, elimination of wiring in a tool can be beneficial in that the space normally used by wiring can now be used for other components. In embodiments requiring communication between tools in different drill pipes, wireless communication can avoid the complication of connecting wires between drill pipes when the drill pipes are being coupled together. Use of the fractal-shaped antenna in these embodiments is beneficial because of the increased antenna efficiency for the space available in downhole applications enables a more powerful wireless signal than would be possible with a conventional antenna in the same available area or volume. In addition, because the fractal-shaped antenna can be tuned to more than one non-harmonic resonant frequency, communication between different downhole tools in the same drill string can occur simultaneously. For example, duplex communication (i.e., communication over two channels at the same time) between a first tool and a second tool in the same drill string can occur without interference by using two frequencies where each tool has the same fractal-shaped antenna tuned for each of the two frequencies. Further, the downhole electronics can include a fractal-shaped antenna for communicating wirelessly with various downhole tools disposed at the same drill string. For example, the downhole electronics using the fractal-shaped antenna can issue commands to or receive data from the various downhole tools. In another example, a chain of downhole tools, each having a fractal-shaped antenna, may relay commands or data back and forth to the downhole electronics. It can be appreciated that using multiple frequencies for communication will enable simultaneous communication over multiple channels. While the downhole electronics may communicate wirelessly with various downhole tools, the downhole electronics may communicate with surface devices such as a surface processing system using standard telemetry such as wireline, mud-pulse, wired drill pipe, acoustic, optical, electromagnetic or other method as known in the art. Hence, in one or more embodiments, the downhole electronics may receive commands from the surface using standard telemetry and relay the commands wirelessly to one or more downhole tools. In addition, the downhole electronics may receive data wirelessly from one or more downhole tools and relay that data to a surface device using the standard telemetry. Relay functions may be performed by relay electronics having analog or digital processors and associated components such as memory as is known in the art.

In downhole communication embodiments, each fractal-shaped antenna may be coupled to a transmitter, a receiver, or a transceiver, which combines the functions of the transmitter and receiver in one unit, depending on the desired communication function. For example, a downhole tool configured to sense a property may only be required to transmit measurement data to the downhole electronics. In this case, the sensor will only need to be coupled to a transmitter and the downhole electronics will only need to be coupled to a receiver although each may be coupled to a transceiver for standardization purposes. Further, the transmitter, receiver, or transceiver may include an interface for converting signals into or from a format required for communication. The interface may include a digital-to-analog converter (DAC) or an analog-to-digital converter (ADC) for communicating signals to or from a digital communication format. Alternatively, signals may be communicated in an analog format (e.g., AM or FM) and may require an interface to convert from one analog format to another analog format.

The fractal-shaped antennas for communication may be configured as the fractal-shaped antennas are for transmitting electromagnetic energy into and receiving electromagnetic energy from subsurface materials as discussed above (e.g., transmission direction and sensitivity direction directed outward from tool or having an outward vector component) for signal transmission through the drilling fluid in the annulus and/or the formation. Alternatively, the fractal-shaped antenna for communication may have a transmission direction and sensitivity direction directed inward into the tool (or have an inward vector component) for signal transmission through the drilling fluid internal to the drill string. The above embodiments may be particularly useful when communicating between drill pipes. When downhole tools are in the same housing or BHA, then the fractal-shaped antennas may be directed towards each other.

In support of the teachings herein, various analysis components may be used, including a digital and/or an analog system. For example, the downhole electronics 9, the computer processing system 11, the transmitter 14, the receiver 15, or the switching network 61 may include digital and/or analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

The term “carrier” as used herein means any device, device component, combination of devices, media and/or member that may be used to convey, house, support or otherwise facilitate the use of another device, device component, combination of devices, media and/or member. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first” and “second” do not denote a particular order, but are used to distinguish different elements.

While one or more embodiments have been shown and described, modifications and substitutions may be made thereto without departing from the spirit and scope of the invention. Accordingly, it is to be understood that the present invention has been described by way of illustrations and not limitation.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for estimating a property of a subsurface material, the apparatus comprising:
a carrier configured to be conveyed through a borehole penetrating the subsurface material;
a transmitter configured to transmit a first electrical signal;
a first energy interface device disposed at the carrier, coupled to the transmitter, and configured to transmit at least one of electromagnetic energy and electrical energy into the subsurface material;
a second energy interface device disposed at the carrier and configured to receive at least one of return electromagnetic energy and return electrical energy due to at least one of transmitted electromagnetic energy and transmitted electrical energy interacting with the subsurface material;
a receiver coupled to the second antenna and configured to receive a second electrical signal from the second energy interface device; and
a processor coupled to the receiver and configured to estimate the property using the second electrical signal;
wherein at least one of the first energy interface device and the second energy interface device is a fractal-shaped antenna comprising a base motif figure and at least one scaled down replication of the base motif figure, the at least one replication being a change from the base motif by at least one of a linear displacement translation and a rotation, and a position of the replication upon the base motif figure is by at least one of rotation, translation, and stretching.

2. The apparatus according to claim 1, wherein the first energy interface device comprises a first antenna and the second energy interface device comprises a second antenna.

3. The apparatus according to claim 1, wherein the first antenna and the second antenna are the same antenna.

4. The apparatus according to claim 2, wherein at least one of the first antenna and the second antenna having the fractal shape is disposed circumferentially around a longitudinal axis of the carrier.

5. The apparatus according to claim 2, wherein an outer surface of a tool body of the carrier has a recess with a shape of an outline of at least one of the first antenna and the second antenna having the fractal shape and at least one of the first antenna and the second antenna having the fractal shape is disposed in the recess.

6. The apparatus according to claim 5, wherein an outer surface of the at least one of the first antenna and the second antenna disposed in the recess is flush to or recessed from the outer surface of the tool body.

7. The apparatus according to claim 6, further comprising an adhesive configured to attach at least one of the first antenna and the second antenna disposed in the recess to the tool body or an intervening material.

8. The apparatus according to claim 5, further comprising a magnetic permeable material disposed between the recess and the at least one of the first antenna and the second antenna disposed in the recess.

9. The apparatus according to claim 1, further comprising an electrically conductive element coupled to at least one of the first antenna and the second antenna having a fractal shape and extending into a tool body of the carrier, the element being coupled to at least one of the transmitter and the receiver.

10. The apparatus according to claim 2, wherein at least one of the first antenna and the second antenna is disposed within a non-metallic tool body of the carrier.

11. The apparatus according to claim 2, wherein at least one of the first antenna and the second antenna having the fractal shape comprises a plurality of connections to a switching network coupled to the processor, the processor being configured to connect one or more selected connections to the transmitter or the receiver or to short one or more selected connections in order to steer at least one of the first antenna and the second antenna in a selected direction.

12. The apparatus according to claim 2, wherein at least of the first antenna and the second antenna having the fractal shape is resonant at a plurality of non-harmonic frequencies.

13. The apparatus according to claim 1, wherein at least one of the first energy interface device and the second energy interface device not being the fractal-shaped antenna comprises one or more electrodes configured for at least one of galvanic coupling and capacitive coupling with the subsurface material.

14. The apparatus according to claim 1, wherein the property is a resistivity or a dielectric constant.

15. The apparatus according to claim 1, wherein the subsurface material comprises at least one of an earth formation and a material disposed in the borehole.

16. The apparatus according to claim 1, wherein the carrier comprises one of a wireline, a sickline, a drill string, or coiled tubing.

17. A method for estimating a property of a subsurface material, the method comprising:
conveying a carrier through a borehole penetrating the subsurface material;
transmitting at least one of electromagnetic energy and electrical energy into the subsurface material using a first energy interface device disposed at the carrier and coupled to a transmitter configured to transmit a first electrical signal to the first energy interface device;
receiving at least one of return electromagnetic energy and return electrical energy from the subsurface material due to the at least one transmitted electromagnetic energy and transmitted electrical energy interacting with the formation using a second energy interface device disposed at the carrier and coupled to a receiver configured to receive a second electrical signal from the second energy interface device; and
estimating the property using a processor coupled the receiver and configured to estimate the property using the second electrical signal;
wherein at least one of the first energy interface device and the second energy interface device is a fractal-shaped antenna comprising a base motif figure and at least one scaled down replication of the base motif figure, the at least one replication being a change from the base motif by at least one of a linear displacement translation and a rotation, and a position of the replication upon the base motif figure is by at least one of rotation, translation, and stretching.

18. The method according to claim 17, further creating a reference signal with which to compare using the processor at least one of the first electrical signal and the second electrical signal.

19. The method according to claim 17, wherein the first electrical signal is the reference signal.

20. The method according to claim 17, wherein the at least one of the first energy interface device and the second energy interface device being the fractal-shaped antenna comprises a plurality of connections to a switching network coupled to the processor, and the method further comprises steering a direction of sensitivity of at least one of the first antenna and the second antenna using the processor, the processor being configured to connect one or more selected connections to the transmitter or the receiver or to short one or more selected connections in order to steer the direction of sensitivity of at least one of the first antenna and the second antenna having the fractal shape in a selected direction.

21. The method according to claim 17, wherein at least one of the first energy interface device and the second energy interface device not being the fractal-shaped antenna comprises one or more electrodes configured for at least one of galvanic coupling and capacitive coupling with the subsurface material.

22. The method according to claim 17, wherein the property is a resistivity or a dielectric constant.

23. The method according to claim 22, further comprising looking up in a lookup table at least one of the resistivity and the dielectric constant based on the second electrical signal using the processor.

24. The method according to claim 17, wherein the subsurface material comprises at least one of an earth formation and a material disposed in the borehole.
